(19) United States
(12) Patent Application Publication
(10) Pub. No.: US 2007/0133426 A1
(43) Pub. Date: Jun. 14, 2007

(54) Data encoding and decoding method for transmitting multiple redundant copies of a data packet

(75) Inventor: Peter Chambers, Phoenix, AZ (US)

Correspondence Address: PATENT LAW GROUP LLP, 2635 NORTH FIRST STREET, SUITE 223, SAN JOSE, CA, 95134, US

(73) Assignee: Micrel, Inc.

(21) Appl. No.: 11/295,325

(22) Filed: Dec. 6, 2005

(51) Int. Cl. H04L 12/26; H04J 1/16

(52) U.S. Cl. 370/252; 370/235

(57) ABSTRACT

A method for transmitting information from a transmitter to a receiver over a forward only communication channel includes generating and transmitting multiple data packets at each input data event. Each data packet includes a data field having a first data portion encoding an identification code identifying the input data event where the identification code uniquely identifies at least N numbers of successive input data events. The method further includes receiving a first data packet and examining the identification code in the data field of the first data packet. If a data packet containing the same identification code has already been accepted within the last N successive input data events, the first data packet is discarded. If a data packet containing the same identification code has not been accepted within the last N successive input data events, the first data packet is accepted for processing.

### FIELD OF THE INVENTION

The invention relates to a data encoding and decoding method and, in particular, to a method of encoding a data packet to allow multiple redundant copies of the data packet to be transmitted and correctly decoded.

### DESCRIPTION OF THE RELATED ART

Uni-directional data communication systems are known and in wide use. A uni-directional communication system uses only a forward communication channel. There is no backward communication channel and no acknowledgement is sent for data transmission sent from a transmitting node and received by a receiving node. Therefore, uni-direction data communication systems are applied in a point-to-point topology where a single transmitter communicates with a single receiver. One example of a uni-directional data communication system is a remote control system where a remote control transmitter transmits information to a receiver to operate certain functions associated with the receiver.

Remote control systems are uni-directional data communication systems that use a wireless forward communication channel. Thus, a remote control device, that is, the transmitter, transmits information to a receiver through a medium that is subject to noise, data loss, and limited range. FIG. 1 is an exemplary wireless remote control system. A remote control system is adapted to control Christmas lights on a tree. A user pushes a button on the hand-held transmitter to activate a switch inside a remote receiver, perhaps in a front yard, that turns the Christmas lights on and off. In general, the communication between the transmitter and the receiver is via digital data modulated onto an RF carrier. The information is often transmitted in the form of data packets.

Remote control transmitters and receivers are generally very low-cost to build and have limited range. They are also subject to interference from other remote control devices since they use the heavily congested consumer spectrum for data communication. Thus, the typical remote control systems may suffer from poor reception capability, frustrating the user.

One technique available to increase the probability of a transmission from the transmitter causing a response at the receiver (such as the Christmas lights come on when the button on the transmitter is pushed) is to transmit the data packet containing the “push event” multiple times. Simple transmission repetition is quite effective in an environment with intermittent interference.

However, there is a difficulty in applying the “simple repetition” method for remote control systems where actuating a button toggles the functions controlled by the button. For example, a single button on the transmitter may implement the on/off control for the Christmas light. When the Christmas light is turned off, one push of the button on the transmitter turns on the Christmas light while another subsequent push of the same button turns the light off.

If one button push (turn the lights on) produces a string of identical data packets, and a subsequent push (turn the lights off) also produces a similar string of identical packets, then the receiver will have a problem distinguishing the data packets of the first push from the data packets of the second push. That is, if the packets resulting from each and every push are all exactly the same, the receiver cannot tell the difference between the last packet resulting from the first push and the first packet resulting from the second push. A means to distinguish packets associated with each button push is therefore required.

One conventional solution involves using a highly secure “rolling code” system. Rolling code systems are often used in remote control garage door openers. Rolling code systems are complex and typically require microcontrollers and non-volatile storage (e.g. EEPROM) to manage the codes. Other conventional solutions include two-button systems, which use one button for on and another for off. In that case, a push packet from the On button is distinct from a push packet from the Off button.

A data transmission method that allows the use of the simple repetition method in a single button system is desired in order to improve the reliability of data reception.

### SUMMARY OF THE INVENTION

According to one embodiment of the present invention, a method for transmitting information from a transmitter to a receiver over a forward only communication channel includes: at each input data event, generating multiple data packets where each data packet includes a data field having a first data portion encoding an identification code identifying the input data event and a second data portion containing input data information and where the identification code uniquely identifies at least N numbers of successive input data events, transmitting the multiple data packets over the communication channel, receiving a first data packet and examining the identification code in the data field of the first data packet, and determining if a data packet containing the same identification code has been previously accepted within the last N successive input data events. If a data packet containing the same identification code has already been accepted within the last N successive input data events, the method further includes discarding the first data packet. If a data packet containing the same identification code has not been accepted within the last N successive input data events, the method further includes accepting the first data packet and processing the input data information.

According to another aspect of the present invention, a data communication system includes a transmitter generating multiple data packets in response to an input data event for transmission over a forward only communication channel where each data packet includes a data field having a first data portion encoding an identification code identifying the input data event and a second data portion containing input data information and where the identification code uniquely identifies at least N numbers of successive input data events. The data communication system further includes a receiver receiving one or more data packets. The receiver examines the identification code in the data field of each received data packet and determines if a data packet containing the same identification code has been previously accepted. In operation, the receiver discards received data packets containing the same identification code as that of a data packet that has been previously accepted within the last N successive input data events and the receiver accepts received data packets containing different identification codes as that of data packets that have been previously accepted within the last N successive input data events. The receiver processes the input data information of the accepted received data packets.

The present invention is better understood upon consideration of the detailed description below and the accompanying drawings.

### BRIEF DESCRIPTION OF THE DRAWINGS

FIG. 1 is an exemplary wireless remote control system.

FIG. 2 depicts a data communication system where an encoder transmits multiple repeated packets of information to a decoder over a communication channel.

FIG. 3 illustrates the data fields in a data packet according to one embodiment of the present invention.

FIG. 4 illustrates the bit structure of a Data field in a data packet according to one embodiment of the present invention.

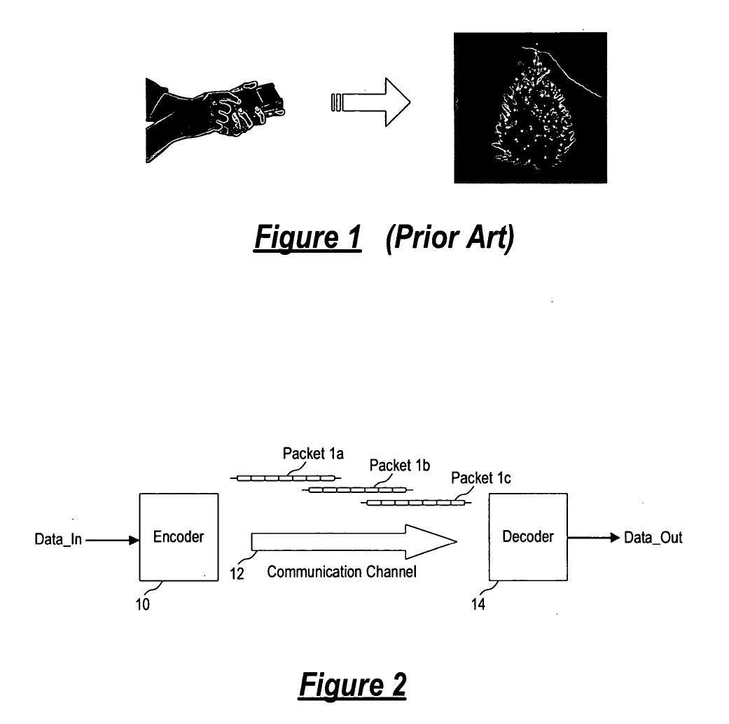

### DETAILED DESCRIPTION OF THE PREFERRED EMBODIMENTS

In accordance with the principles of the present invention, a data encoding and decoding method for transmitting multiple redundant copies of a data packet encodes each set of redundant data packets with an identification code so that each set of redundant data packets is uniquely identified from other sets of redundant data packets. In this manner, redundant data packets belonging to the same set can be correctly identified and discarded if a valid data packet from the set has already been received. In one embodiment, the identification code is an n-bit code where n is at least one. Furthermore, in one embodiment, the identification code for each set of redundant data packets is selected sequentially from 0 to 2ⁿ⁻1.

The encoding and decoding method of the present invention has particular application in a uni-directional data communication system with a single transmitter and a single receiver configured in a point-to-point topology. By using the encoding and decoding method of the present invention, the transmitter can transmit multiple copies of the same information packet to increase the chance of correct reception by the receiver. The receiver, upon receipt of the data packets, examines the identification code in each data packet to determine whether the data packet is a redundant data packet or is a data packet containing new information. Once a data packet has been validly received by the receiver, the receiver can then discard redundant data packets carrying the same information and therefore having the same identification code. When the receiver receives a data packet having an identification code different than the previously received data packet, the receiver recognizes the data packet as carrying new information and accepts the data packet for processing.

FIG. 2 depicts a data communication system where an encoder transmits multiple repeated packets of information to a decoder over a communication channel. In the illustration shown in FIG. 2, the data communication system is shown as having an encoder 10 transmitting data packets and a decoder 14 receiving data packets sent over a communication channel 12. It is understood that encoder 10 is one component in a transmitter device and the transmitter device includes other components to effectuate the encoding and transmission of the input data Data_In. Also, it is understood that decoder 14 is one component in a receiver device and the receiver device includes other components to implement the reception and decoding of the received data packets to generate the output data Data_Out. The data communication system shown in FIG. 2 is illustrative only and components not critical to the practice of the present invention are not shown to simplify the discussion.

Furthermore, it is assumed that the data communication system of FIG. 2 is one where the input signal Data_In implements a toggle control of a certain function at the receiver. Thus, each time Data_In is asserted, the same data content is sent from the encoder to the decoder and the decoder generates output data Data_Out to toggle the state of the function it is controlling. For example, a single button on the transmitter implements the on/off control for a light. When the light is turned off, one push of the button on the transmitter turns on the light while another subsequent push of the same button turns the light off. In the present description, the term “input data event” is used to describe an action at the transmitter which triggers the generation of an input data signal Data_In to be encoded and transmitted to the decoder over the communication channel. Thus, an input data event can be a push of a button or an actuation of a switch on a transmitter device or remote control device associated with encoder 10.

In accordance with the data encoding and decoding method of the present invention, for each input data event, encoder 10 transmits multiple repeated data packets to decoder 14 through communication channel 12. As shown in FIG. 2, three data packets Packet 1a, 1b and 1c, containing identical data content, are transmitted from encoder 10 to decoder 14. Decoder 14, receiving data packets Packet 1a, 1b and 1c must be able to distinguish between packets that are from the same input data event or different input data event.

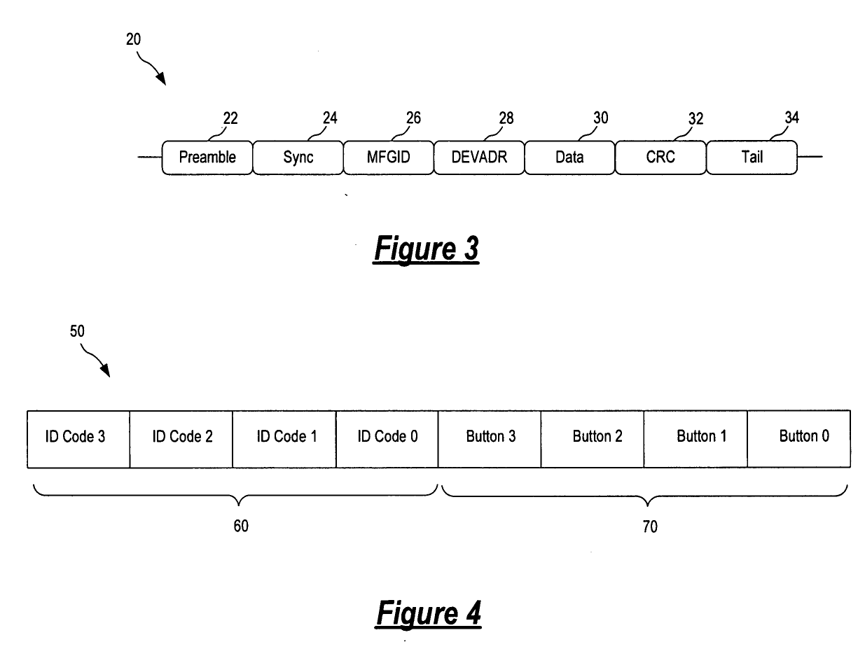

In accordance with the data encoding and decoding method of the present invention, data packets Packet 1a, 1b and 1c are encoded with an identification code to identify that each of the packets belong to the same input data event. FIG. 3 illustrates the data fields in a data packet according to one embodiment of the present invention. Referring to FIG. 3, a data packet 20 in accordance with the present invention includes a Preamble field 22 containing the data packet preamble information, a Sync field 24 containing the synchronization information, a MFGID field 26 containing the manufacturer identification information, a DEVADR field 28 containing the device address information, a Data field 30 containing data content of the packet, a CRC field 32 containing error correction information, such as a cyclic redundancy check code, and finally, a Tail field 34 containing the data packet tail information. Except for Data field 30, the functions of the different fields in data packet 20 are conventional and will not be further described.

In accordance with the data encoding and decoding method of the present invention, Data field 30 containing the data content is configured to contain an identification code as well as the input data information indicative of the input data Data_In received by the encoder. FIG. 4 illustrates the bit structure of a Data field in a data packet according to one embodiment of the present invention. Referring to FIG. 4, a Data field 50 containing the data content of a data packet includes a first portion 60 containing an identification code and a second portion 70 containing the actual data information. In the present embodiment, data field 50 has 8 bits and each of first and second portions 60, 70 contains 4 bits. Thus, in the present embodiment, the identification code for the data packet is a 4-bit code and a total of 16 codes is available to identify separate input data events.

The data information portion 70 also includes 4 bits which can be assigned to four different buttons of the transmitter. The exact arrangement and assignment of the data information portion 70 in data field 50 are not critical to the practice of the present invention. In the present illustration, when Button 0 on the transmitter is pushed or actuated initiating an input data event, the data bit field containing Button 0 in data field 50 will be encoded with the predetermined information (such as a logical “1”) to indicate the desired data information for the data packet. One of ordinary skill in the art would appreciate that the arrangement of the data information portion 70 of data field 50 will vary depending on the application of the data communication system.

The identification code encoded in first portion 60 of data field 50 is a code selected from 0 to 2ⁿ−1 where n is the number of bits in first portion 60. Thus, in the present illustration, the identification code is a binary value from 0 to 15. For each input data event, such as when Button 0 is pushed, encoder 10 generates multiple data packets where each data packet includes a data field containing an identification code having a first value and a data information portion with the data bit associated with Button 0 be asserted. Thus, a set of multiple data packets associated with a given input data event of the button will have an identical data field containing a unique identification code identifying the input data event.

When Button 0 is pushed again to initiate another input data event, encoder 10 generates multiple data packets again but the data packets will now have a different identification code in the data field. In one embodiment, encoder 10 selects the identification code in sequence from 0 to 2ⁿ−1 where each successive input data event generates sets of data packets with an incrementing identification code. When the last code is reached, the identification code can return to 0 to start incrementing again. In another embodiment, encoder 10 selects the identification code in random from 0 to 2ⁿ−1. The exact manner in which the identification code is selected for each set of data packets is not critical to the practice of the present invention. It is only necessary that the identification code changes with each input data event, such as the push of a button on the transmitter.

By having each set of multiple data packets associated with each input data value (such as each push of a given button) assigned a different identification code, decoder 14 is now able to distinguish data packets for each input data event. Specifically, decoder 14, upon receipt of a data packet, will examine the identification code. If no previous data packet having the same identification code has been accepted, then decoder 14 will recognize the data packet as a new input data event and will accept and process the data packet. Once the decoder has accepted a data packet with a given identification code, the decoder can then discard other incoming data packets having the same identification code. In this manner, the encoder can transmit multiple data packets to increase the probability of reception at the decoder and the decoder can correctly receive data packets associated with each input data event. The data encoding and decoding method of the present invention provides a simple, low-cost, and very effective means for the decoder to uniquely identify separate input data events, such as separate button pushes by the user.

One of ordinary skill in the art would appreciate that the identification code in the data field of the data packet of the present invention can be implemented using any number of data bits. Although a one-bit identification code can be used, it is apparent to one of ordinary skill in the art that a one-bit identification is not ideal for a single-button toggle system because the two identification codes available for a one-bit code may not be sufficient to distinguish between multiple input data events. Thus, in general, a multi-bit identification code is desired. For example, having 16 codes dramatically reduces the possibility of erroneous packet rejection as the user has to initiate 16 input data events, such as 16 pushes of a button, before the identification code repeats to cause the decoder to reject the data packet.

The above detailed descriptions are provided to illustrate specific embodiments of the present invention and are not intended to be limiting. Numerous modifications and variations within the scope of the present invention are possible. The present invention is defined by the appended claims.

I claim:

1. A method for transmitting information from a transmitter to a receiver over a forward only communication channel, the method comprising:
at each input data event, generating a plurality of data packets, each data packet comprising a data field having a first data portion encoding an identification code identifying the input data event and a second data portion containing input data information, wherein the identification code uniquely identifies at least N numbers of successive input data events;
transmitting the plurality of data packets over the communication channel;
receiving a first data packet and examining the identification code in the data field of the first data packet;
determining if a data packet containing the same identification code has been previously accepted within the last N successive input data events;
if a data packet containing the same identification code has already been accepted within the last N successive input data events, discarding the first data packet; and
if a data packet containing the same identification code has not been accepted within the last N successive input data events, accepting the first data packet and processing the input data information.

2. The method of claim 1, wherein the identification code comprises an n-bit code where n is at least 1, the identification code thereby uniquely identifying at least 2ⁿ numbers of successive input data events.

3. The method of claim 2, wherein generating a plurality of data packets at each input data event comprises selecting an identification code to identify the input data event having a value between 0 and 2ⁿ−1.

4. The method of claim 3, wherein selecting an identification code to identify the input data event having a value between 0 and 2ⁿ−1 comprises:
selecting an identification code in sequence from 0 to 2ⁿ−1 for each successive input data event, the identification code returning to 0 after the 2ⁿ−1 value has been selected.

5. The method of claim 3, wherein selecting an identification code to identify the input data event having a value between 0 and 2ⁿ−1 comprises:
selecting an identification code in random from 0 to 2ⁿ−1 for each successive input data event.

6. A data communication system comprising:
a transmitter generating a plurality of data packets in response to an input data event for transmission over a forward only communication channel, each data packet comprising a data field having a first data portion encoding an identification code identifying the input data event and a second data portion containing input data information, wherein the identification code uniquely identifies at least N numbers of successive input data events; and
a receiver receiving one or more data packets, the receiver examining the identification code in the data field of each received data packet and determining if a data packet containing the same identification code has been previously accepted,
wherein the receiver discards received data packets containing the same identification code as that of a data packet that has been previously accepted within the last N successive input data events and the receiver accepts received data packets containing different identification codes as that of data packets that have been previously accepted within the last N successive input data events, the receiver processing the input data information of the accepted received data packets.

7. The system of claim 6, wherein the identification code comprises an n-bit code where n is at least 1, the identification code thereby uniquely identifying at least 2ⁿ numbers of successive input data events.

8. The system of claim 7, wherein the transmitter selects an identification code having a value between 0 and 2ⁿ−1 to identify each input data event.

9. The system of claim 8, wherein the transmitter selects an identification code in sequence from 0 to 2ⁿ−1 for each successive input data event, the identification code returning to 0 after the 2ⁿ−1 value has been selected.

10. The system of claim 8, wherein the transmitter selects an identification code in random from 0 to 2ⁿ−1 for each successive input data event.
